(19) United States
(12) Patent Application Publication
(10) Pub. No.: US 2001/0005392 A1
(43) Pub. Date: Jun. 28, 2001

(54) Method of determining the quality of adhesion in a laminar structure

(76) Inventors: Brigitte Schutz, Linkenheim-Hochstetten (DE); Gerd Krafft, Eggenstein-Leopoldshafen (DE); Lazlo Duszla, Karlsruhe (DE)

Correspondence Address: Klaus J. Bach, 4407 Twin Oaks Drive, Murrysville, PA, 15668, US

(21) Appl. No.: 09/790,097

(22) Filed: Feb. 22, 2001

Related U.S. Application Data
(63) Continuation-in-part of application No. PCT/EP99/06566, filed on Sep. 7, 1999.

(30) Foreign Application Priority Data
Sep. 14, 1998 (DE) 198 41 969.4

(51) Int. Cl. G01N 25/72

(52) U.S. Cl. 374/5; 374/45

(57) ABSTRACT

In a method of determining the quality of a bond between layers of a laminated body wherein a laser pulse is applied to one side of the body such that the heat travels from the one side through the bond to the other side, the time-dependent temperature change on the other side is recorded, the delay time to reach, at the other side, a predetermined percentage value of the maximum temperature is determined and this delay time is compared with a calibration curve for quantifying the quality of the bond between the layers.

This is a continuation-in-part application of international application PCT/EP99/06566 filed Sep. 7, 1999 and claiming the priority of German application 198 41 969.4 filed Sep. 14, 1998.

### BACKGROUND OF THE INVENTION

The invention relates to a method of determining the quality of adhesion in a laminated structure as it is known from “Determination of Thermal Contact Resistance in Two-Layer Composites by Flash Method”, Transactions of Welding Research Institute of Osaka University, Vol. 15, No. 2 pages 21-31, 1986; Inoune, K., Ohmura, E.

Joining materials for joining parts are increasingly used in the industry, particularly in the preparation of laminated structures. It is therefore important to be able to determine the quality of adhesion in laminated structures.

Most of the testing methods for determining the adhesion such as stress tests are destructive tests. The few non-destructive testing methods such as ultrasonic examinations provide only information with regard to defects or flaws, but do not permit the determination of the quality of the adhesion between the laminations of laminated structures (Habenicht G., 1997, “Kleben” (Cementing), Springer Verlag). With the laser flash principle (Bräuer, G., Dusza, L., Schulz, B.; “The New Laser Flash Equipment LFA - 427”, Interceram 41 7/8, 1992) a short energy pulse is applied to the front side of a sample body and the temperature change caused thereby at the backside is measured. With homogeneous materials the time of the temperature rise depends mainly on the length and the heat conductivity of the sample. The laser flash method is utilized worldwide for determining the heat conductivity. The equations for determining the thermal contact resistance with the laser flash method have not been successful because of the incomplete mathematical solution (Balageas D. L., Krapez, J. C., Cielo P. 1986, “Pulsed Photothermal Modeling of Layered Materials”, J. Appl. Phys., 59(2) 348-359).

The thermal contact resistance can now be used as a measure for the adhesion between two material layers if the new corrected mathematical model is utilized (Dusza, L., “Determination of Thermal Contact Resistance with Heat Loss Correction Using the Flash Method”, High Temp. - High Press (1995/1996), 27/28, 475-483). This however requires extensive iterative calculations for solving transcendental equations until an optimal adaptation of the calculated temperature curve to the respective measured values is achieved.

It is the object of the present invention to provide a method of determining the quality of the adhesion in a laminated structure which is non-destructive and which does not require a complicated mathematical input and procedure.

### SUMMARY OF THE INVENTION

In a method of determining the quality of a bond between layers of a laminated body wherein a laser pulse is applied to one side of the body such that the heat travels from the one side through the bond to the other side, the time-dependent temperature change on the other side, is recorded, the delay time to reach, at the other side, a predetermined percentage value of the maximum temperature is determined and this delay time is compared with a calibration curve for quantifying the quality of the bond between the layers.

The thermal contact resistance is the resistance to the flow of heat across an interface. A high thermal contact resistance means a bad transfer of the heat waves which indicates a bad coupling of the two materials at the interface. Accordingly, the thermal contact resistance is inversely proportional to the adhesion quality. The method according to the invention is based on the understanding that, using the laser flash process, the thermal contact resistance is proportional to the time interval after which a certain percentage of the maximum temperature has been reached. 50% is an optimal value for this percentage. This novel non-destructive contact-free and rapid process can be utilized in the industry for determining the adhesion or, respectively, for checking hardening or drying processes in the joining medium.

Qualitative evidence concerning the connection strength of lamination structures can be provided by utilizing only simple time measurements in a temperature - time diagram.

Below, the invention will be described in greater detail on the basis of an example.

### DESCRIPTION OF AN EXEMPLARY EMBODIMENT OF THE INVENTION

After a short laser impulse has been applied to one side of a sample, the temperature of the sample at the side opposite the side to which the laser impulse was applied first increases, reaches a maximum and then drops again. This temperature distribution is recorded for example by an infrared sensor. The time delay for reaching half the maximum temperature value is an optimal parameter for the strength of the lamination connection of the two materials.

However, time periods for achieving values of anywhere between 20 and 90% of the maximum temperature may be employed as parameters.

If the measurement is to be quantified a calibration curve has to be recorded.

To this end, samples with different adhesion qualities are prepared. This can be achieved by the addition of different amounts of inert materials to the layer forming the connection or by a differing percentage coverage of the interface area (for example, 20, 40, 60, 80 and 100%), wherein the area divisions should be small with respect to the area exposed to the laser beam. From these samples, the “half-temperature times” and, by conventional means, the tensile strength are determined. From the sample values, a calibration curve is prepared.

For drying processes, the thermal contact resistance will increase over time.

This characteristic change of the contact resistance makes it possible to control or monitor a moist layering with the method according to the invention.

The thermal contact resistance provided by an epoxy resin cement decreases over time. After two hours, the decrease trend of the monitored contact resistance changes.

The lattice-like polymerization of the cement begins, for example, two hours after the two components have been mixed (manufacturer specification). An increase of the contact resistance after two hours indicates such a chemical change within the epoxy cement. When the polymerization is completed the contact resistance decreases again until the jointure has reached its final strength.

In contrast to ultrasound procedures, the new method permits not only the detection of faults (in a yes/no answer fashion), but the quantitative results are sensitive even to small changes in the jointure.

The method of the thermal contact resistance can be utilized in the production, quality control, and in development laboratories and also in the paint and lacquer manufacture, in the manufacture of cements and glues, in the manufacture of laminated materials and in the manufacture of motor vehicles and airplanes. The method permits also the examination of the quality of various joining processes that is the quality of soldering or welding joints or the quality of the adhesion of coatings (for example, the coatings of turbine blades).

What is claimed is:

1. A method of determining the quality of a bond between layers of a laminated body, comprising the steps of:
applying to one side of said body a laser pulse, recording the time dependent temperature change on the other side of said body opposite the side to which said laser pulse was applied, determining the time delay to reach, at said other side, a predetermined percentage value of the maximum temperature which time delay is a measure for the quality of said bond, and comparing said time delay with a calibration curve for quantifying the quality.

2. A method according to claim 1, wherein said predetermined percentage value is 50% of said maximum temperature.

3. A method according to claim 1, wherein said laminated body comprises cemented layers.

4. A method according to claim 1, wherein said laminated body comprises a coated member.

5. A method according to claim 1, wherein said laminated body is formed by layers joined by a large number of individual bond areas and said laser pulse is provided by a beam covering a plurality of said bond areas.
